(19) United States
(12) Patent Application Publication
(10) Pub. No.: US 2017/0073062 A1
(43) Pub. Date: Mar. 16, 2017

(54) Variable Geometry Wingtip

(71) Applicant: Gregory S. Firth, Vista, CA (US)

(72) Inventor: Gregory S. Firth, Vista, CA (US)

(21) Appl. No.: 14/852,496

(22) Filed: Sep. 12, 2015

(51) Int. Cl. B64C 23/06; B64C 3/38

(52) U.S. Cl. CPC B64C 23/065; B64C 3/38

(57) ABSTRACT

A variable geometry wingtip is comprised of two deformable yet relatively stiff airfoils (6, 7) that work in compression and tension against each other to change shape. There is only one moving part in the assembly (5) with no internal mechanisms to facilitate morphing. The wingtip (5) consists of a lower airfoil (7) and an upper airfoil. (6) The base of the lower airfoil (8) is mounted horizontally to an under surface (4) of an outboard end (2) of a wing. (1) The upper airfoil (6) has a portion (9) which is allowed to retract and extend from an upper surface (3) of the outboard end (2) of the wing. (1) A single projecting wingtip (11) is formed at an intersection (10) of the lower and upper airfoils. (6, 7)

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### FIELD OF INVENTION

The present disclosure relates to a wingtip device capable of changing shape for predetermined flying conditions.

### BACKGROUND OF INVENTION

Changing the shape of an aircraft wing is commonly known as morphing, deforming, or variable geometry. Morphing aerodynamic structures have been explored and researched in such publications as: “Hierarchical Models of Morphing Aircraft,” by Michael I Friswell published 11 Oct. 2012 and “Morphing Aircraft: The Need for a New Design Philosophy,” from the Ankara International Aerospace Conference on 11 Sep. 2013. Morphing has previously been applied to change the cord, dihedral, span, and twist of aircraft wings. Other studies focus on materials that are suitable for morphing structures such as: “Technology Integration for Active Poly-Morphing Winglets Development,” from the Conference on Smart Materials on 28 Oct. 2008 and, “The application of thermally induced multistable composites to morphing aircraft structures,” from the Department of Aerospace Engineering, Bristol University 2008. Materials have been developed which allow morphing to occur with the application of heat, current or pressure.

Most morphing aerodynamic structures rely on mechanical means to deform a wing to a specific shape. Extending and retracting a winglet from the outboard end of a wing is one method. Examples of wingtips capable of this function are illustrated in “Retractable Multiple Winglet,” by Roger Grant filed 9 May 2006 and U.S. Pat. No. 8,336,830 B2 with title, “Retractable aircraft wing tip,” by David Scott Eberhardt filed on 3 Oct. 2008. The structures explained in these patents do not exhibit morphing but instead use hard mechanical surfaces to effectively change the wingspan of an aircraft. Changing the wingspan has the benefit of altering lift, air speed and drag.

A rotational downward pointing winglet has been the subject of many studies and publications. This configuration is shown to increase ground effect by creating a pressure wave between the underside of a wing and the ground. The resulting pressure wave provides an extended glide with the addition of a slower wing tip stall speed. An aircraft with winglets pointing toward the ground is therefore able to land and take off at lower speeds which is a great benefit. Examples of winglets with this feature are seen in U.S. Pat. No. 6,547,181 B1 with title, “Ground effect wing having a variable sweep winglet,” filed on 29 May 2002 by Zachary C. Hoisington and Blaine K. Rawdon and U.S. Pat. No. 8,342,456 B2 with title, “Wing tip device,” filed 8 Jun. 2011 by Alan Mann.

Breaking up vortices that form in the airstream after the wingtip is possible using many different shapes and structures. One very effective shape is a spiroid wingtip. The wingtip curves back toward the origin of a wing which separates the high pressure under side of a wing from the low pressure upper side. Additionally, the vertical wing area of the spiroid adds stability in flight. A spiroid wingtip is seen in US 20120312929 A1 with title, “Split Spiroid,” by Louis B. Gratzer filed 11 Jun. 2012. The spiroid wingtip structure has a void located in the center of an elliptical wingtip. The void is not subject to the low to high pressure airflow. The airstream in flight is left relatively undisturbed in this region increasing the effectiveness of vortex reduction. The spiroid wingtips are stagnate and non-deformable because it would not be practical to incorporate such a feature.

A ventral fin placed on a winglet interrupts the air stream traveling from the low pressure to the high pressure surfaces on a wing. Since the airflow is generally rising in that area of the wingtip, additional lift is generated that would otherwise be unrealized. An example of a wingtip with a ventral fin is seen in US 2012/0312928 A1 with title, “Split Blended Winglet,” by Louis B, Gratzer filed on 11 Jun. 2012.

Variable geometry is another name for morphing. A definition for these terms as applied to aircraft is the ability to change form to facilitate predetermined flying conditions. Some examples of variable geometry wingtips are, “Variable camber aircraft wing tip,” U.S. Pat. No. 4,429,844A by Stephen T. Brown Frank D. Statkus filed 29 Sep. 1982 and US 20080308683 A1 with title, “Controllable winglets,” filed on 15 Jun. 2007 by Mithra M. K. V. Sankrithi Joshua B. Frommer. Different flying conditions include: take off, landing, soaring, diving and turbulence. For example, a wingtip shape for takeoff, landing or low speed would be the previously described ground effect shape. A wingtip shape for diving or high speed would be a retracted or tucked wing. A wing shape for soaring or gliding would include an extended wing span. A wing for turbulence would include a structure that is flexible or deformable. In turbulent air a flexible structure bends when excessive forces are acting on a wingtip. The variable geometry wingtip device described below is able to assume shapes for all these flying conditions including rigid and flexible structures.

### BRIEF SUMMARY OF THE INVENTION

A structure that incorporates all the benefits and features previously described is made using two deformable yet relatively stiff airfoils that work in compression and

tension against each other to change shape. There is only one moving Page 4 part in the assembly with no internal mechanisms to facilitate morphing. The wingtip is comprised of a lower airfoil and an upper airfoil. The base of the lower airfoil is mounted horizontally to an under surface of an outboard end of a wing. The upper airfoil has a portion which is made to retract and extend from an upper surface of the outboard end of the wing. A single projecting wingtip is formed at an intersection of the lower and upper airfoils.

### BRIEF DESCRIPTION OF DRAWINGS

FIG. 1. A perspective view of an exemplary wingtip in a retracted shape for high speed and diving.

FIG. 2. A perspective view of an exemplary wingtip in a semi-extended shape for normal flying conditions and normal wing loading.

FIG. 3. A perspective view of an exemplary wingtip in a semi-extended shape during low wing loading.

FIG. 4. A perspective view of an exemplary wingtip in a soaring shape, deformed by excessive forces caused by turbulence and high wing loading.

FIG. 5. A perspective view of an exemplary wingtip for soaring and gliding during normal wing loading.

FIG. 6. A perspective view of an exemplary wingtip in a soaring shape during low wing loading.

FIG. 7. A perspective view of an exemplary wingtip in a ground effect shape, deformed by excessive forces caused by turbulence.

FIG. 8. A perspective view of an exemplary wingtip in a ground effect shape during normal wing loading.

### REFERENCE NUMERALS

1. Assembly showing a typical aircraft wing.
2. Outboard end of a typical aircraft wing.
3. Upper surface of a typical aircraft wing.
4. Lower surface of a typical aircraft wing.
5. Wingtip assembly
6. Upper airfoil
7. Lower airfoil.
9. Portion of the upper airfoil which retracts and extends from upper surface of aircraft wing.
10. Intersection of lower and upper airfoils.
11. Projecting wingtip or ventral fin.
12. Leading edge.
13. Trailing edge.

### DETAILED DESCRIPTION OF THE INVENTION

The variable geometry wingtip 5 morphs into a wide variety of shapes however, there are many other benefits and features not yet disclosed. An important aspect of the device is that it has two working airfoils 6, 7 that double the effect of changing shapes. Each wingtip 5 is independently controlled providing a pilot the ability to turn based on changing air speed at a wingtip and not bank angle. Decreased bank angle results in decreased side slip. Effective wing surface area decreases as bank angle increases. To initiate a turn using the device a pilot would extend one wingtip and retract the other. The two airfoils 6, 7 work in harmony with each other in many other ways.

In reference to the drawing diagrams, the lower airfoil 7 is mounted flat to an under surface 4 of the wing 1 and the upper airfoil 6 is in alignment with an upper surface 3 of the wing 1 at an outboard end. 2 This configuration creates a larger opening at a leading edge 12 and a narrower opening at a trailing edge. 13 This alignment creates a ram air effect between the two airfoils 6, 7 causing inflation which results in increased stability of the structure. An example of ram air effect is seen in a wind sock used to determine wind direction at most airfields.

Still another aspect of the two airfoils 6, 7 is that the leading edges 12 have a thin profile with minimal surface area exposed to incoming airflow. Drag is reduced with a thin leading edge. Another source of drag is induced drag which is the objective of most wingtip devices. Induced drag is caused by vortices that form from the high pressure area under 4 the wing 1 circling around a wingtip to the low pressure area at the upper surface. 3 Placing obstacles in the path of that airflow help to diminish vortices. In the variable geometry wingtip, an entirely different phenomena is occurring due to the two airfoils. 6, 7 The airstream that flows in a void between the two airfoils 6, 7 is not subject to the low to high pressure airflow. The airstream flows relatively undisturbed in this region. The high pressure flows along the curved surface of the lower airfoil 7 until an intersection 10 with upper airfoil 6 forms a projecting wingtip. 11 The projecting wingtip 11 utilizes the rising airflow to create additional lift while minimizing vortices.

One very important feature of the wingtip 5 is the simple and lightweight construction. Only one moving part is necessary to morph the wingtip 5 into all the shapes used for different flying conditions. That moving part is the upper airfoil 6 itself. The structure is extremely durable and not easily damaged. The wingtip will tend to deform on impact and then return to the original intended shape. As previously mentioned, the two airfoils 6, 7 work in compression and tension against each other to change shape. In the extended state, the upper airfoil 6 is in compression and the lower airfoil 7 is in tension. In the retracted state, the upper airfoil 6 is in tension and the lower airfoil 7 is in compression. The structure become rigid as the forces are increased at the far extended and far retracted states. The structure becomes flexible when equilibrium is reached between these two states.

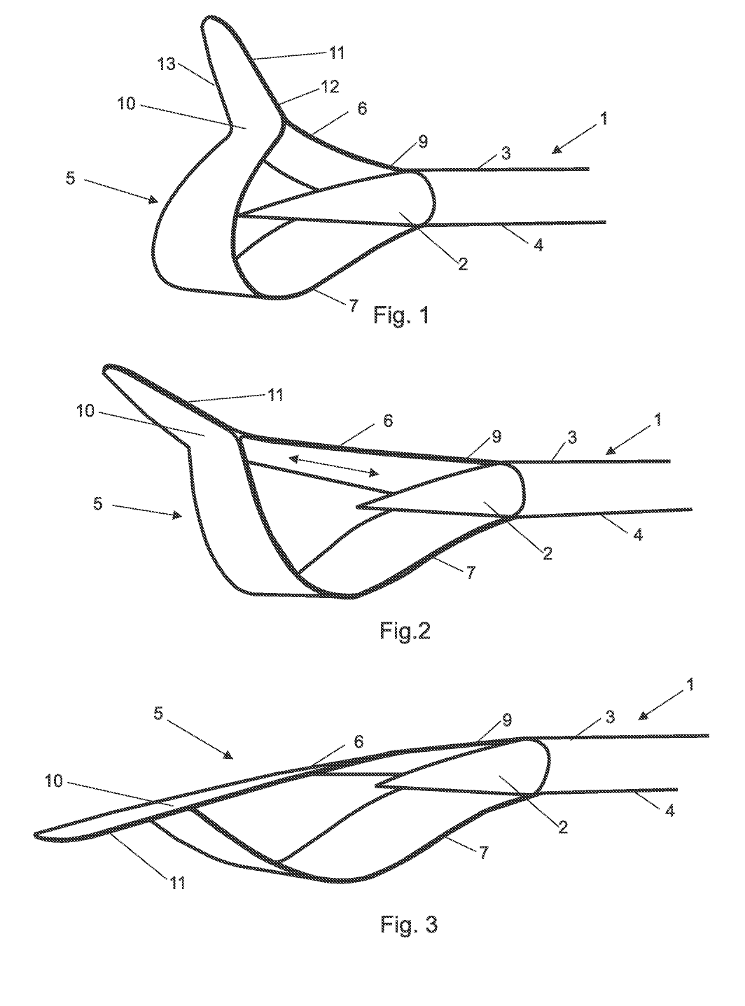

The shape created in FIG. 1 is a high speed, retracted spiroid like shape. The projecting wingtip or ventral fin 11 interrupts the rising airflow from the lower airfoil 7 providing extra lift. The structure is rigid and does not deform when subjected to high wing loading because the lower airfoil 7 provides sufficient tension for the retracted and compressed upper airfoil. 6 The upper airfoil 6 assumes a blended winglet shape. The lower airfoil 7 curves below the aircraft wing 1 forcing the high pressure airflow downward. Another important aspect of the high speed shape is that the horizontal airfoil surfaces decrease and the vertical stabilizing airfoil areas increase. Stabilizing vertical airfoil surfaces at the wingtips are the subject of many aeronautical publications.

Partially extending the upper airfoil 6 with the portion 9 from the outboard end 2 of the wing 1 provides a wingtip shape suited for normal flying conditions as shown in FIGS. 2 and 3. The shape assumed in FIG. 2 is during normal wing loading. The shape assumed during low wing loading is illustrated in FIG. 3. The structure has become semi-flexible because the forces between the two airfoils 6, 7 has decreased. The horizontal airfoil surface has increased and the vertical airfoil surface has decreased. The lower airfoil 7 still has a downward component and the upper airfoil 6 is further extended with the ventral fin 11 intercepting upward airflow. In turbulent air conditions, the structure will further deform similar to FIG. 1 which allows excessive forces to pass thereafter to return to the original shape.

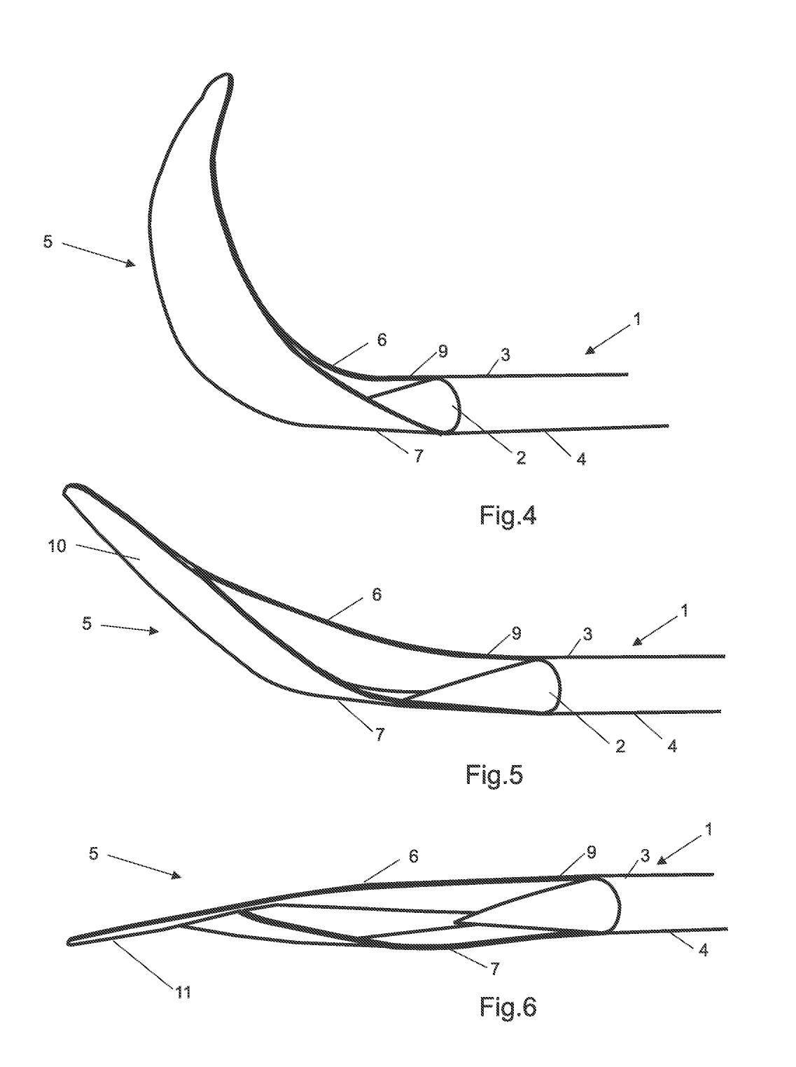

Extending the upper airfoil 6 further utilizing the portion 9 from the outboard end 2 of the aircraft wing 1 as seen in FIGS. 4, 5 and 6 will equalize the forces between the two airfoils. 6, 7 The flying condition best suited for this shape is soaring and gliding because the maximum amount of horizontal wing surface area is exposed to rising air. The ventral fin 11 has morphed into a horizontal wing surface. During turbulent or high speed conditions, the wingtip 5 will deform into a blended winglet shape as seen in FIG. 4. During normal flying conditions, the wingtip 5 is extended which gives a pilot an indication of rising air as seen in FIG. 5. Pilots in gliders often find rising air only under one wingtip and then circle around to make a full penetration into the rising air mass. In strong thermal conditions, gliders are often thrown into unintended wing-overs from rigid wingtip surfaces reacting to violent updrafts. Low wing loading in this configuration will cause the wingtip to assume a shape as seen in FIG. 6.

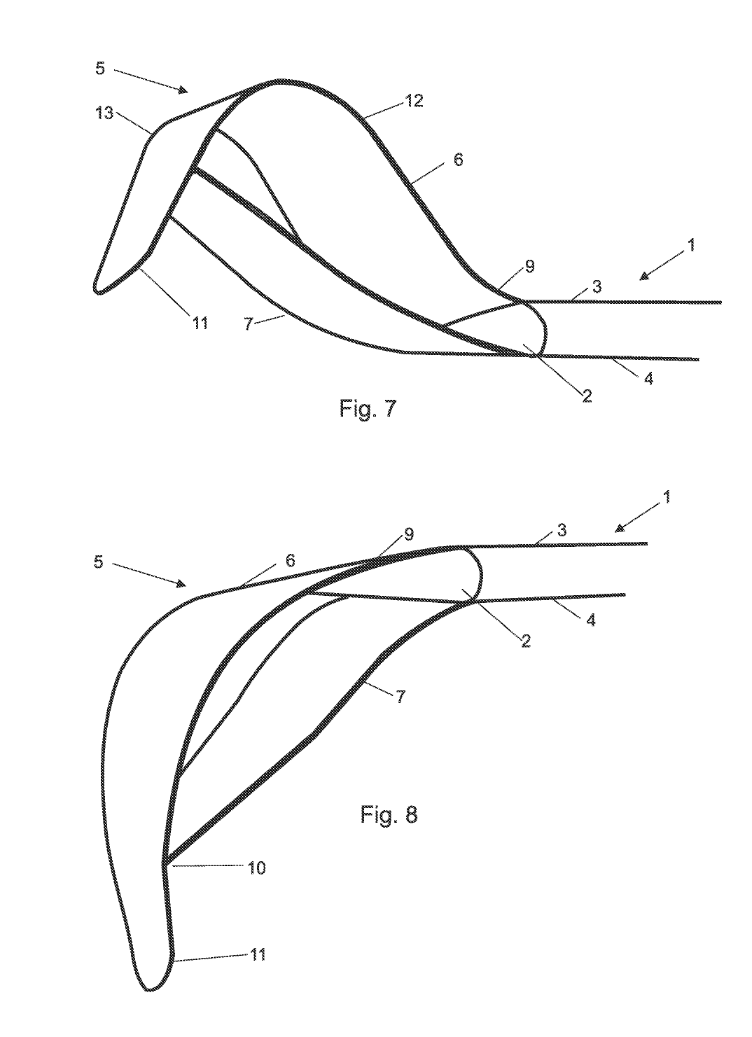

Further extending the upper airfoil 6 will provide a wingtip shape best suited for landing or takeoff as illustrated in FIGS. 7 and 8. The downward pointing wingtip 11 and airfoil surfaces 6, 7 create a pressure wave between the ground and the under surface of the wing. 4 The wingtip 5 has once again morphed providing the ventral fin. 11 The wingtip stall speed has decreased resulting in a stable slow flying speed with the addition of an extended glide. The vertical airfoil surfaces have increased which also adds stability at the lower airspeeds. The upper airfoil 6 is in a compressive state and the lower airfoil 7 is in a tensile state which is the complete opposite from the high speed configuration. The structure is semi-flexible because the fully extended airfoil 6 has the maximum possible wing surface exposed. Turbulence is often encountered during landing close to the ground. A semi-flexible structure deforms in turbulence as shown in FIG. 7. As air speed decreases the shape will resume a full downward pointing wingtip shape as seen in FIG. 8. Unlike other ground effect winglets, the variable geometry wingtip has two working airfoils both of which point towards the ground. The result is that the increased vertical surfaces further increase stability, provide an even slower stall speed and double the ground effect.

### CONCLUSION, RAMIFICATIONS AND SCOPE

The subject matter disclosed in this description relates to a wingtip capable of morphing into multiple shapes. The subject matter however does not discuss different airfoil shapes and sizes. It is obvious to one skilled in the art that other shapes and sizes can be implemented using the structure. For example, the wingtip structure is capable of enlarging to encompass an entire wing or be made smaller for specific purposes. Another variation of the invention would be to allow the lower airfoil to extend and retract and the upper airfoil to be mounted. Furthermore the structure of the variable geometry wingtip is applicable to a multitude of aerodynamic uses including: propellers, rotors and wind generated electricity. Any application where a morphing aerodynamic structure is implementable, the variable geometry wingtip can be used.

What is claimed is:

1. A variable geometry wingtip, comprising:
a lower airfoil and an upper airfoil with attachment of said lower airfoil to an under surface of the outboard end of a wing; and
said upper airfoil provided with a portion which is allowed to retract and extend from an upper surface of the outboard end of said wing; and
a connection at an intersection of said lower and upper airfoils which forms a single projecting wingtip;
whereby morphing of said airfoils provide multiple shapes for different flying conditions.

2. The wingtip of claim 1 wherein the upper airfoil is mounted to the upper surface of the wing and the lower airfoil extends and retracts from the under surface of the wing.

3. The wingtip of claim 1 with a fully extended upper airfoil whereby a ground effect shape is formed.

4. The wingtip of claim 1 with a fully retracted upper airfoil whereby a high speed shape is formed.

5. The wingtip of claim 1 with a partially extended airfoil whereby a shape for soaring and gliding is formed.

6. The wingtip of claim 1 wherein the structure becomes rigid in the far extended and retracted states and flexible in the partially extended state.

7. A variable geometry aircraft wingtip attachable to an outboard end of an aircraft wing; with
said wing having an upper and lower surface, and
a leading edge and a trailing edge being the fore and aft intersections of said upper and lower surfaces,
said wingtip comprising:
an upper airfoil and a lower airfoil with
said lower airfoil attached to said lower surface of the outboard end of said wing, and
said upper airfoil configured to retract and extend from said upper surface of the outboard end of said wing, and
a connection at an intersection of said upper and lower airfoils forming a single projecting wingtip;
whereby deformation of said airfoils provide multiple shapes for different flying conditions.

8. The wingtip of claim 7 wherein the distance between the leading edges is greater than the distance between the trailing edges of the upper and lower airfoils whereby inflation of the wingtip through a ram air effect adds rigidity to the structure.

9. The wingtip of claim 7 wherein equalization of compressive and tensile forces between the two airfoils provide a flexible structure whereby turbulence and excessive wing loading causes the wingtip to assume a curved blended winglet shape.

10. The wingtip of claim 7 wherein the upper airfoil is fully extended and the lower airfoil is in tension causing the wingtip to assume a downward pointed position; whereby ground effect is increased causing stall speed to decreased and provide an extended glide.
